(19) United States
(12) Patent Application Publication
(10) Pub. No.: US 2015/0120842 A1
(43) Pub. Date: Apr. 30, 2015

(54) METHOD AND SYSTEM FOR SENDING EMAIL TO MULTIPLE RECIPIENTS WITH RECIPIENT SELECTED SPECIFIC ATTACHMENTS

(71) Applicant: Tina Cummings HUGGINS, NASHVILLE, TN (US)

(72) Inventor: Tina Cummings HUGGINS, NASHVILLE, TN (US)

(21) Appl. No.: 14/067,211

(22) Filed: Oct. 30, 2013

(51) Int. Cl. H04L 12/58

(52) U.S. Cl. CPC H04L 51/08
USPC 709/206

(57) ABSTRACT

A method and system is provided for managing groups of individuals to receive an electronic message with recipient specific selected document attachments. The method and system associates one or more documents with individual recipients prior to composing an email message. After an email message is composed, the email message is sent to the selected recipients with respective associated documents for the recipients as previously selected.

### FIELD OF THE INVENTION

The present invention relates to a method and system for sending email to a plurality of recipients with attachments and in particular a method and system for sending one or more electronic documents to a plurality of recipients in which each recipient is sent an email with recipient specific electronic documents as attachments.

### BACKGROUND OF THE INVENTION

Communication is increasingly being conducted using electronic messages commonly referred to as electronic mail i.e. email. Email allows one to exchange information between recipients in the form of text messages contained within the body of an email (hereinafter referred to as the “email message”) as well as attachment of documents to the email message. Often one wishes to communicate the same information with more than a single recipient. Convention email systems allow one to address an email message to multiple recipients.

One limitation of conventional email systems is that all email recipients will receive the same email with all attachments that may be included. However, a sender may not wish all recipients to receive all attachments. For example, a sender may wish to exclude sending certain attachments to various recipients. Alternatively, a sender may wish each recipient to receive a different attachment to the single email message. Conventional email systems do not allow a sender to send a single email message and selectively identify individuals to receive the email message with recipient specific, selected documents or attachments specific to the selected individual recipients.

Recently, proposed but not commercially available or implemented email systems have been considered for indicating whether recipients of an email will get an email attachment. For example, U.S. Patent Application Publication No.: 2002/0013817 to Collins et al, hereinafter “the '817 application” describes a proposed system for first composing an email message addressed to multiple recipients and having one or more documents attached. Subsequently, a user can indicate whether recipients (i.e. addresses) to the email message will receive the previously attached documents. One disadvantage of this proposed system is that one must first attach all documents, include all recipients (i.e. add all addressees), and then identify which of the recipients (the email addressees) will receive the previously attached documents to the initiated email message. A second disadvantage of this system is that there is a 10 meg size limitation per email. Such a system is complex and not well suited for conventional mobile computing. For example, the '817 email method and system is not well-suited for creating email messages using a smartphone, tablet computer or personal digital assistant (PDA) (collectively referred to a “mobile devices”). These aforementioned mobile devices excel in communication by having a simple, well executed user interface that allow the use of streamline mobile applications (commonly referred to as “apps”). Accordingly, the method and system in the '817 application, requiring initiation of an email with all recipients and all attachments made prior to identifying which recipient is to receive an attachment is not well suited for mobile computing.

A second proposed method and system for sending email is described in U.S. Pat. No. 7,548,952 to Delia et al, hereinafter “the '952 patent”. As with the method and system in the '817 application, a sender composes an email message by first attaching all documents to an email message and adding all recipients (addressees). Next, a user/sender selects individual recipients previously addressed to the email. The sender is then prompted to select one or more of the previously attached documents to the email message to be included with an email sent to the selected recipient. For example, FIG. 1 of the '952 patent describes at step 10 a user attaching one or more files to an email, displaying individual recipients addressed to the email at step 14, followed by a user identifying a recipient (step 16) to receive one of the previously attached documents (step 18).

There is a need in the art for an improved method and system for managing recipients or individuals to receive recipient specific, selected documents when sending a single email message to multiple recipients.

### SUMMARY OF THE INVENTION

A method and system are provided for managing a group of individuals to receive an electronic message with recipient specific selected document attachments. Unlike conventional email methods and systems, the present method and system first identifies a group of individuals to receive one or more attachments to a future, or intended to be composed, email message. After the group of individuals are identified, individual recipients are selected and subsequently, one or more electronic documents are selected and associated with the selected individual. Finally, an email message is composed and email is sent to the recipients with the recipient specific attachments.

The present method and system for managing a group of individuals to receive recipient specific electronic documents is achieved using a simple set of steps or tasks that are easily performed using a mobile device, e.g. a smartphone, tablet computer and/or a PDA. In addition, the present method and system can be implemented using a personal computer as well. Unique aspects of the present method and system which distinguish them over prior known and conventional email methods and systems include first identifying individuals or a group of individuals (i.e. recipients), and then selecting and associating or attaching specific electronic file(s) or document(s) for each individual prior to composing a single email message to be sent to the group. Once specifically selected files are individually associated or attached to each recipient, a single email message is composed. The composed email message is then sent individually to all recipients, but each recipient receives only his or her specifically selected attachments.

In various alternative embodiments, the method and system may use “cloud” storage or remote servers (e.g. third party, network servers) which store or “host” electronic documents that are subsequently associated with individual recipients to be included with email messages sent to individuals as selected.

The present invention, in one form, relates to a method for managing a group of recipients to receive one or more recipient specific selected electronic documents to be attached to respective recipient email addresses as individually selected document attachments. The method includes identifying recipients to receive one or more electronically sent documents using a computing device having a computer processor. One of the recipients is selected using the computing device and possible electronic documents to be subsequently sent to the selected recipient is presented in response to selecting the one recipient. This occurs prior to attaching any documents to an email message. One or more documents are selected using the computing device to be subsequently attached to the email message after the email message is created. The selected documents are associated with the selected recipient. Optionally, the steps of selecting one of the recipients, displaying possible documents, selecting one or more documents and associating the documents are repeated for each remaining recipient. An email message is composed only after completing all iterations of selecting, one by one, recipients, displaying possible documents, selecting one or more of the documents and associating the documents with the recipients are completed. Next, in an iterative process, the method generates emails by associating the email message with each of the recipients and his or her respective associated documents. In this iterative process, emails are generated by combining the email message with each respective one of the recipient's email address and the associated recipient's document(s). The iterative process repeats generation of emails and associates the email message with the remaining recipients with associated document(s), one recipient at a time, if the remaining recipient(s) is/are to receive different document(s) than the other recipient(s).

In one further embodiment, documents are stored in memory remote from the computing device. In one further specific embodiment, sending the email message to each individual recipients comprises downloading select documents to the computing device e.g. from a server to which the mobile device is operatively connected and sending the email from the computing device to the recipients with the associated respective recipient specific documents. In an alternative embodiment, sending the email message to each of the recipients comprises sending the email messages from a remote server wherein the remote server sends separate email messages to each of the individuals with the associated respective documents.

The present invention, in another form thereof, relates to a system for managing a group of individuals to receive one or more individual specific electronic documents to be attached to respective electronic messages as recipient specific selected document attachments. The system includes a computer processor, a user interface having an input device, a display and memory. The processor executes computer instruction for: (a) identifying recipients to receive a respective email message using a computing device having a computer processor; (b) selecting one of the recipients using the computing device; (c) displaying, on a display of the computing device, possible documents to be subsequently associated with a recipient and to be subsequently sent with an email message to the selected one of the recipients in direct response to (b) selecting the one of the recipients to receive one or more documents, and without attaching documents to an email message; (d) selecting one or more documents using the computing device, to be subsequently included with an email sent to the respective recipient; (e) associating the selected document(s) with the selected recipient; (f) optionally repeating (b)-(e) for each remaining recipients; (g) creating an email message and association recipient respective selected documents only after completing all iterations of (b)-(e); (h) generating an email by associating the email message with one of the recipients with respective associated selected document(s) only after completing all iterations of (b)-(e); (i) sending the email to the one recipient wherein the one recipient receives the email message with the document(s) associated with the one recipient; and (j) repeating (h) and (i) for the remaining recipients, if the remaining recipients are to receive different document(s) than the one recipient.

The present method and system have features and advantages not found in prior email methods and systems. The present method and system uses a series of simple and efficient steps for associating electronic documents with individuals e.g. email addresses, and not associating all attachments within an email message. As a result, one does not attach a large number of documents to an email and then need to perform multiple steps to select the name of the email addresses who is to receive which one of the previous attachments to the email message. Further, the simpler and more efficient present method and system for managing individuals to receive electronic documents is especially well suited to mobile devices such as, smartphones, tablets, PDAs and their associated user interfaces.

In addition, the present method and system allow for sending emails with many more different attachments than using conventional email systems. Prior email systems require all documents for all email recipients to be attached to a single group email message. As a result, there will be a limitation on the total size of all attachments to be sent to all recipients. However, since the present system only attaches the recipient selected specific documents to the email message sent to the respective recipient and not all documents of all recipients, the size of emails sent by the present method and system is less than what is possible using conventional email methods which require all attachments for all recipients to be attached to a single email message. Therefore, in the present method and system, one is not limited by a total email size of all selected documents for all recipients, only the total email size of the selected documents for any respective email recipient.

### BRIEF DESCRIPTION OF THE DRAWINGS

FIG. 1 is a flow chart of one method in accordance with the present invention.

FIG. 2 is a system for implementing the method of FIG. 1.

FIG. 3 is another flow chart of another method in accordance with another aspect of the present invention.

FIG. 4 is a screen display showing how one adds individuals to be managed for receiving selected electronic documents in accordance with one aspect of the present invention.

FIG. 5 is a screen display showing how one adds a new contact to an electronic address book in accordance with the present invention.

FIG. 6 is a screen display showing how one adds a new group of individuals in accordance with the present invention.

FIG. 7 shows how one adds individuals to an existing group of individuals in accordance with the present invention.

FIG. 8 is a screen shot showing how one selects whether individuals receive the same attachment or different attachments.

FIG. 9 shows a user interface for selecting attachments for all individuals to receive.

FIG. 10 is a user interface for selecting individual recipients to receive different attachments.

FIG. 11 is a user interface showing different attachments to be associated with a recipient.

FIG. 12 is a user interface for composing a message for all recipients after selected recipients have been identified and respective one or more documents selected.

FIG. 13 is a schematic showing how recipient associated documents are assembled and sent as respective email in accordance with the present invention.

### DETAILED DESCRIPTION

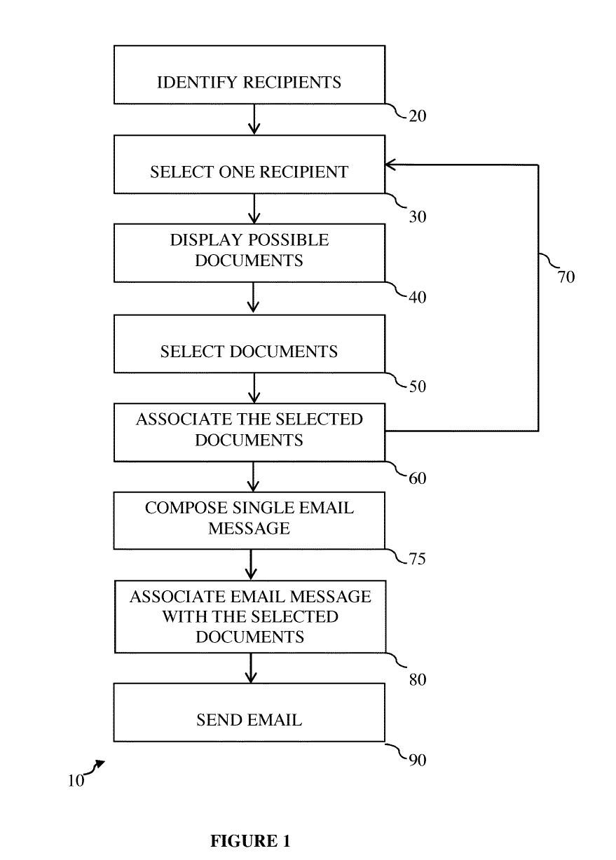

The present method and system will now be described with regard to the Figures which describe various embodiments which can be used to implement the present method and system. Referring now to FIG. 1, method 10 is directed to one embodiment for managing a group of individuals to receive one or more specific recipient specific selected electronic documents. Individual recipients to receive one or more electronic documents are identified (step 20). The individuals can either be selected one by one by entering the individual's name or email address or individuals can be selected from an electronic address book, directory or contact list (e.g. database) conventional in the art. Step 20 can be repeated to add additional recipients. Alternatively, rather than adding individual recipients separately, a group of individuals can be selected or added at step 20.

Next, the identified individual recipients from step 20 are selected, one at a time (step 30). Upon selecting the recipient, possible electronic documents to be associated with the selected recipient are presented (step 40). Subsequently, one selects one or more electronic documents (step 50) and the documents are associated with the selected individual (step 60).

Steps 30-60 are repeated as necessary to select additional recipients to receive individually selected recipient specific electronic documents (step 50).

After all recipients have been identified as necessary to associate electronic documents with the selected recipients single email message is composed (step 75). Next the recipient selected specific documents are associated with the email message (step 80). Accordingly, electronic documents are associated with an email message only after all recipients have been identified and all documents associated with respective recipients. Finally, the email message is sent to each of the recipients with the recipient selected specific electronic documents (step 90).

Referring to associating the email message with selected documents (step 80) in more detail, if each recipient is to receive the same selected electronic documents, a single email is created and the selected electronic documents are attached to the single email. Subsequently, the created email is sent (step 90). Alternatively, if recipients are to receive different electronic documents, the present method creates unique email for each recipient in a loop or iterative manner in which the recipient selected specific documents are attached to respective unique emails with the group email message and subsequently each unique email is sent (step 90). This process is repeated until each unique email for each respective recipient is sent (step 90).

Method 10 can be implemented as software being executed by one or more computer processors e.g. as a computer application running on a computer processor of a smartphone, tablet or PDA. In addition, method 10 can be incorporated into a computer application or software running on a personal computer which includes but are not limited to desktop, laptop/notebook or other client and/or server computers.

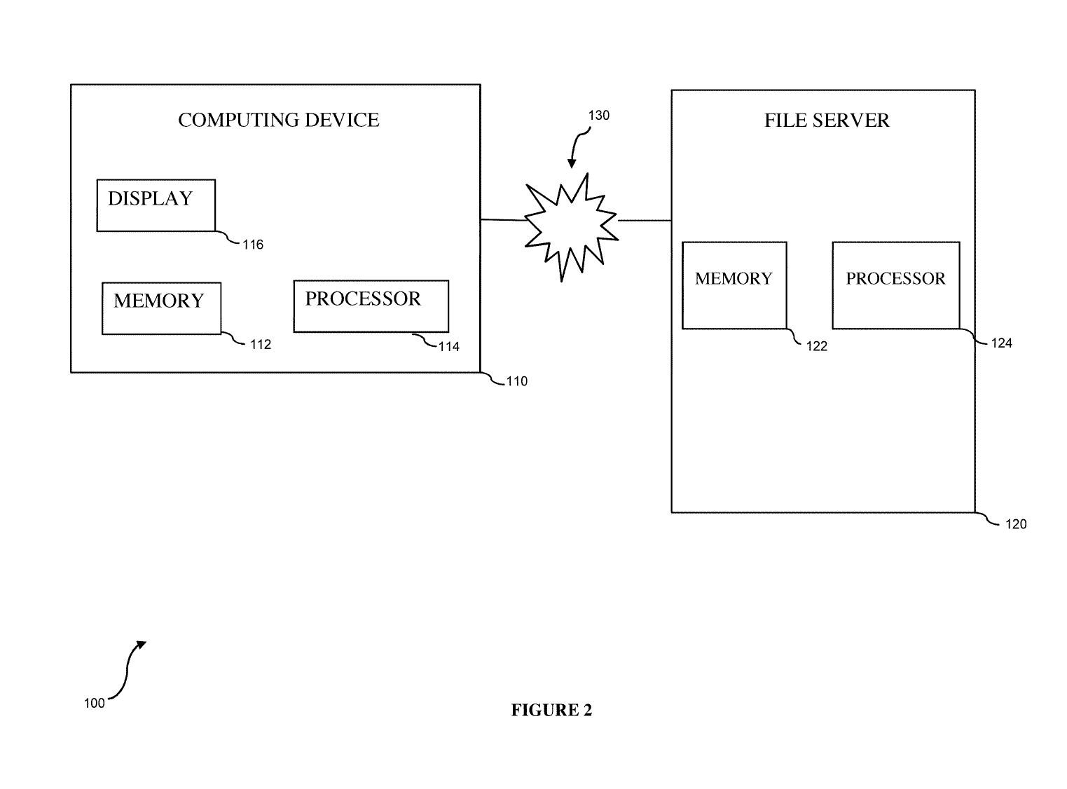

One possible system for implementing method 10 is provided by system 100 of FIG. 2. System 100 includes a computing device 110. Computing device 110 can be a smartphone, tablet computer or PDA. Alternatively, computing device 110 can be any personal computer including but not limited to a desktop or notebook computer or a server which one accesses remotely across a computer network. Computing device 110 has memory 112, processor 114 and display 116. The computing device 110 is wirelessly associated advantageously with a file server 120 via computer network 130. File server 120 has memory 122 and processor 124. The file server 120 can store, in a memory 122, electronic files/documents to be associated with individual recipients to be subsequently attached to respective email messages as individually selected recipient specific electronic documents.

The emails assembled with respective recipient specific attachments (step 80) and subsequently sent (step 90) can be sent via the computing device 110, from file server 120 or another computer server connected to the file server 120 and/or computing device 110. If the emails are assembled and sent from computing device 110, individual electronic documents are transferred from memory 122 of file server 120 to the memory 112 of the computing device 110 (step 80). Subsequently, the computing device 110 sends the individual or unique emails to recipients with the respective selected attachment documents (step 90).

Alternatively, the file server 120 can generate or assemble respective unique email(s) with the email message and the respective recipient selected electronic documents (step 80). Subsequently, the file server 120 sends the emails (step 90). In an alternative manner, a second server (different than server 120) can receive documents from the file server 120 or computing device 110, associate the recipient selected documents with the email message received from the computing device 110, i.e. generate the unique emails and the second server can send the emails to the recipients.

An advantage of the file server 120 or another server assembling emails sending the emails rather than the computing device 110 is that the individual electronic documents or files do not need to be sent from the file server 120 or another server to the computing device 110, subsequently processed by processor 114 of the computing device 110 and then sent from the computing device 110. As a result, the computing device 110 does not need to use its processor 114 and memory 112 to send electronic documents. Further, the bandwidth of the computer network 130 does not need to accommodate the transfer of electronic files between file server 120 and computing device 110. This is especially advantageous if the electronic documents are of a substantial size thereby eliminating the need to download documents to the computing device 110 and then subsequently sending the emails with sizable attachments from the computing device 110 to respective recipients.

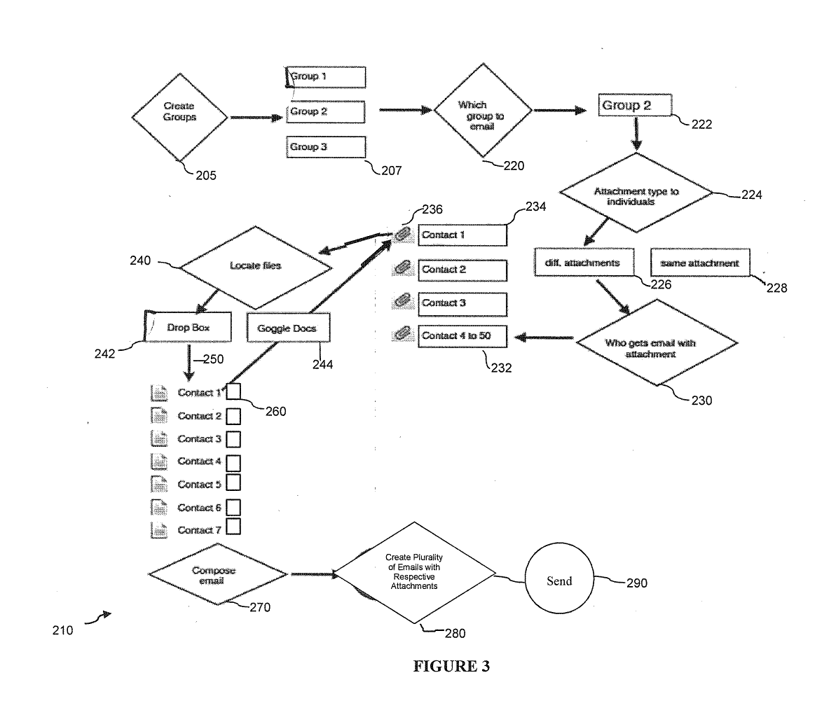

Referring now to the method for managing a group of individuals to receive an electronic message in more detail, shown in the flow chart of FIG. 3, method 210 includes step 205, creating groups comprising individuals (e.g. names with email addresses). For example, three groups 207, are created as Group 1, Group 2 and Group 3. Each group 207 includes multiple recipients. Subsequently, one of the groups is identified (step 220) and displayed (step 222). A user is prompted to determine whether all individuals in Group 2 will receive the same attachment or different attachments (step 224). If different attachments is selected (step 226), one then selects individual recipients (step 230) to associate the selected recipient with a one or more electronic documents.

In this example, Group 2 has 50 individuals identified as contacts 1-50 (232). For each individual recipient or contact that one wishes to send one or more electronic documents, one selects a single recipient (i.e. one at a time) (step 232). For example, one can select an indicia associated with each recipient e.g. a paper clip icon 236 of Contact 1 (step 234). By selecting paper clip icon 236, a user is presented with electronic documents to select for association with recipient of Contact 1 (step 240). A list of documents from a cloud based file server including Dropbox® 242 and Google Docs® 244 can be presented to a user on a display 116 (FIG. 2) of the computing device 110 (FIG. 2). The user then can select one or more of the electronic documents (step 250) to be associated with Contact 1 (234). This process is repeated until all individuals or contacts have been selected and documents associated. As shown in method 210 (FIG. 3), this is repeated for Contacts 2-7 (step 232).

Subsequently, a single email message is composed (step 270) and the individually selected email attachment(s) are associated with the email message (step 280). Subsequently, the email message is sent to each recipient, with the appropriate respective, recipient selected specific document(s) (step 290).

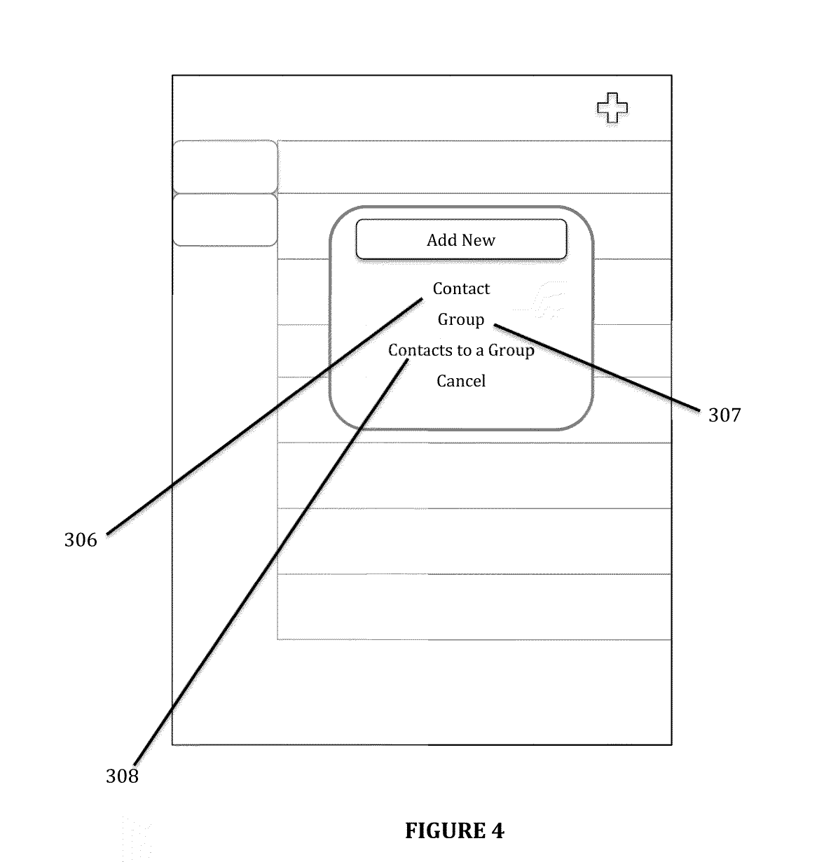

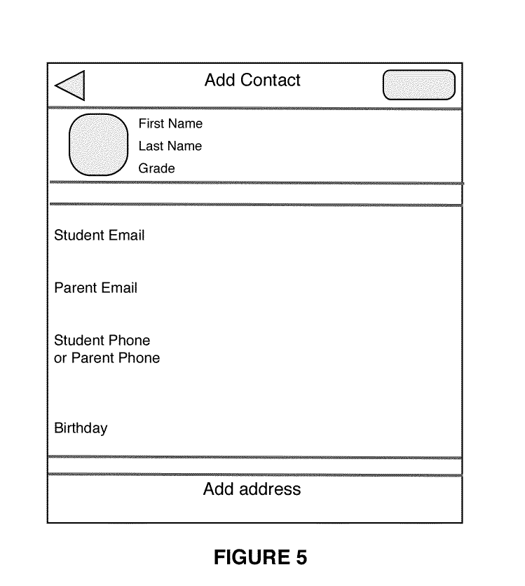

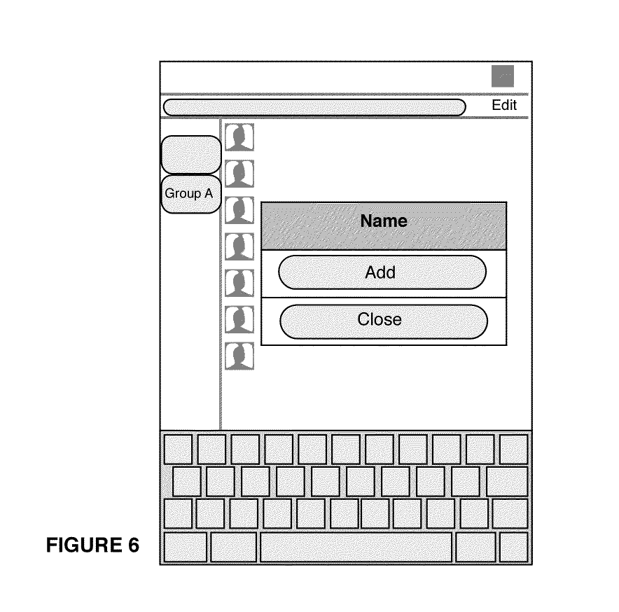

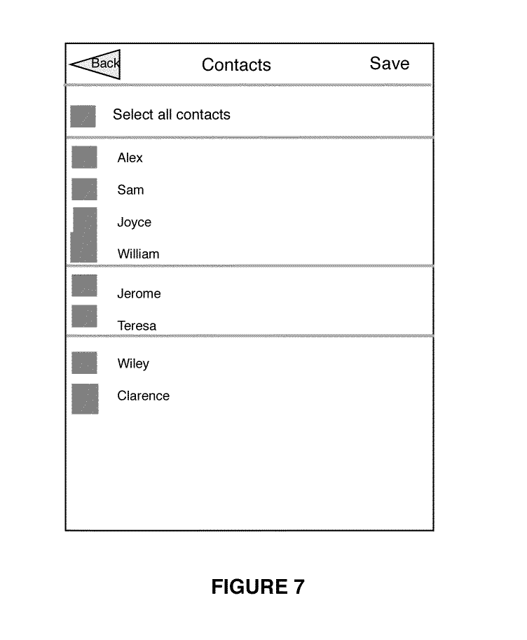

The following example for associating electronic documents with individuals to receive as an attachment to an email message is made with reference to the user interface screen shots of FIGS. 4-12. Referring now to FIG. 4, along with FIGS. 1 and 3, a user interface for implementing method 10, 110 include displaying on display 116 (FIG. 2) options to “add new” Contact 306, Group 307, or “Contacts to Group” 308. For example, selecting “Contact” 306 presents a user the interface of FIG. 5 to allow one to create a new contact not previously in a database or electronic address book of memory 112. Selecting group 307 presents a user with the interface of FIG. 6. Further, a person can add a new contact to an existing group by selecting “Contacts to a Group” 308 (FIG. 4) which then presents one with the interface shown in FIG. 7.

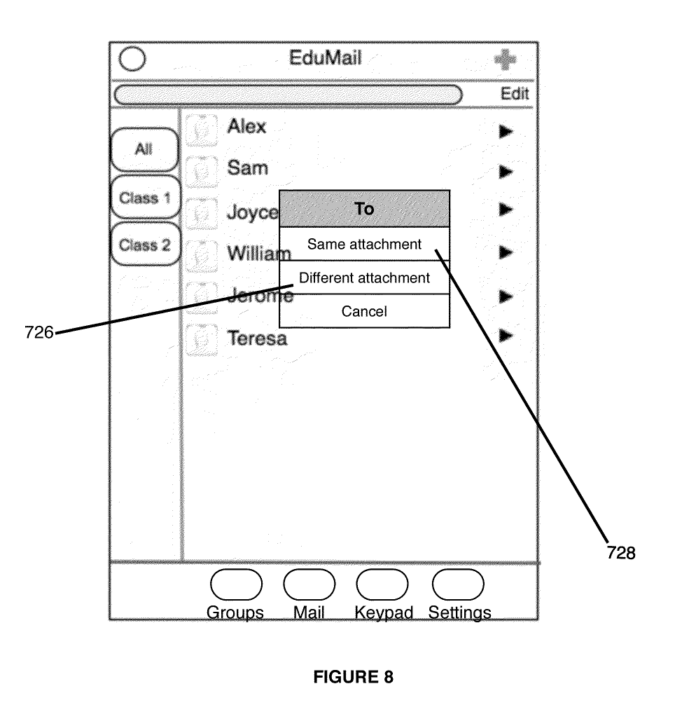

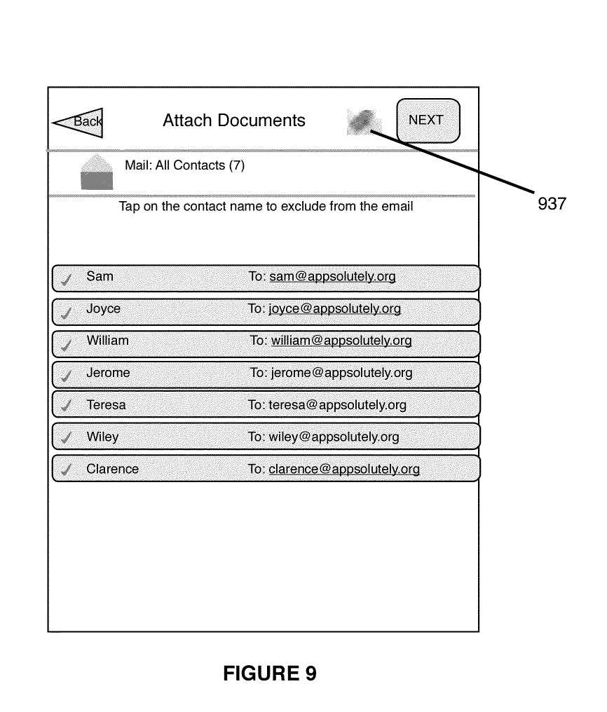

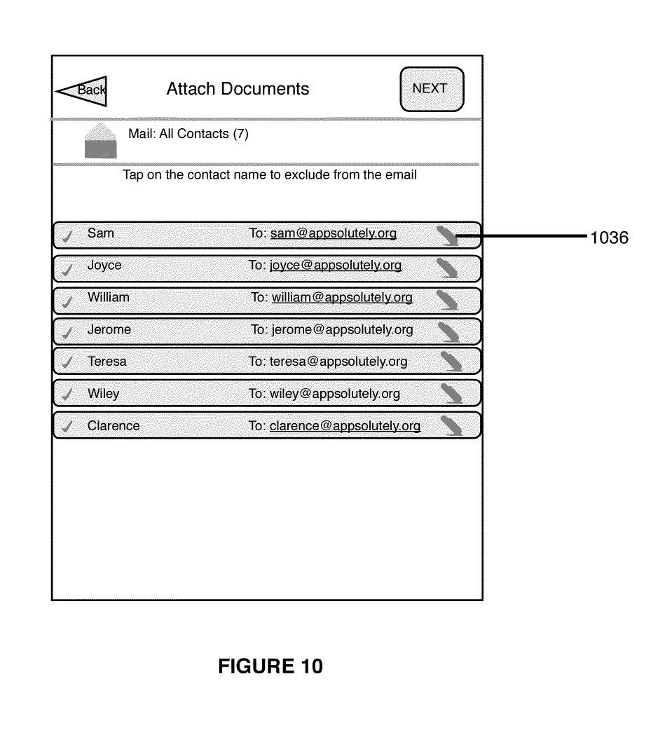

Referring to FIG. 8, after the individuals or groups have been identified (step 20, 220), one selects the attachment type i.e. all individuals receive the same attachment 728 (step 228, FIG. 3) or different attachments 726 (step 226). If all recipients are to receive the same attachment 728 (step 226), the interface of FIG. 9 is displayed. A user clicks on the paper clip 937 and then is directed to select documents to be associated with all recipients. Alternatively, if different attachments 726 are to be associated with respective individuals (step 226, FIG. 3), FIG. 10 is displayed. In FIG. 10, a respective paper clip icon 1036 is associated with each individual recipient, e.g. recipient Abc.

Selecting a respective paper clip 1036 (FIG. 10) prompts a user to select a location of documents to be associated with the respective recipient (step 240). For example, one can be prompted with various cloud based file servers e.g. Google Docs® 244 or Dropbox® 242. Selection of recipients via indicia such as paper clips e.g. paper clip 1036 (FIG. 10) allow one to select individual recipients to receive desired documents.

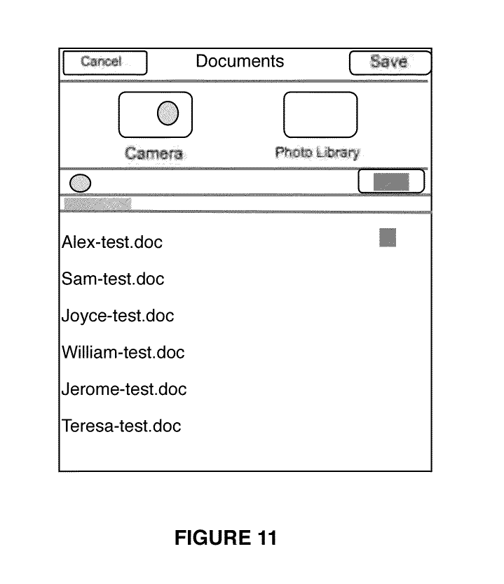

Depending on the software configurations, a user may need to login using username and password to gain access to the cloud based file server e.g. Drop Box® 250, Google Docs® 244. Next, a user is presented with a list of documents to be associated with individuals as shown in FIG. 11, an interface for Google® documents 244. A similar interface is used for Drop Box® or another electronic document file server. One can then select one or more of the electronic documents to be associate with the selected individual, for example, individual ABC who can be associated as Contact 1 (step 250), FIG. 3.

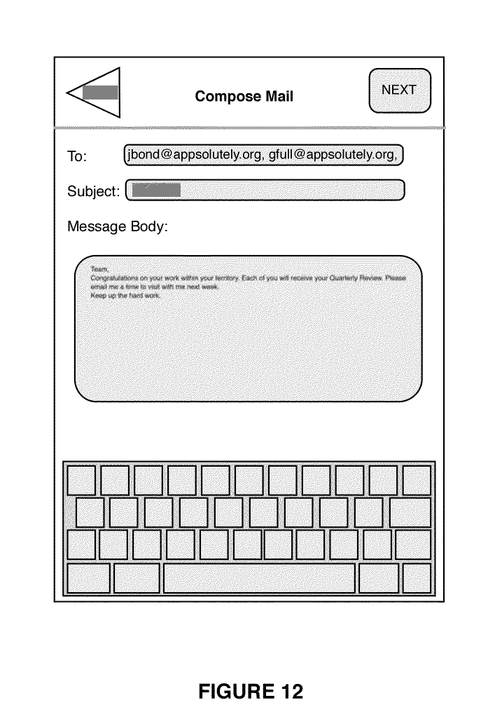

Next, a user composes a single message using the interface as shown in FIG. 12 (step 270), FIG. 3. The “to” field is populated with email addresses corresponding to the recipients identified (step 20, 220). One can enter information regarding the “subject” of the email message. Finally, one can enter a message in the “message by” which will appear in the body of the email received by each of the recipients of the “to” field.

Subsequently, email is generated or assembled (step 80, 280). If each recipient receives the same documents, a single email is generated, associating the selected documents and the message with the email (step 80, 280). Alternatively, if each recipient is to receive specific recipient selected documents, unique email will be generated, one for each recipient in a loop function or iterative fashion in which a unique email is generated, associating the email message with the recipient selected documents (step 80, 280). After each unique email is generated, the email is sent (step 90, 290). This process is repeated for each recipient. (Steps 80, 280; 90, 290). As a result, the email is sent (step 90, 290) to each of the recipients in which each recipient only receives the attachments associated with the email address in the “to” line as associated in step 60, 260.

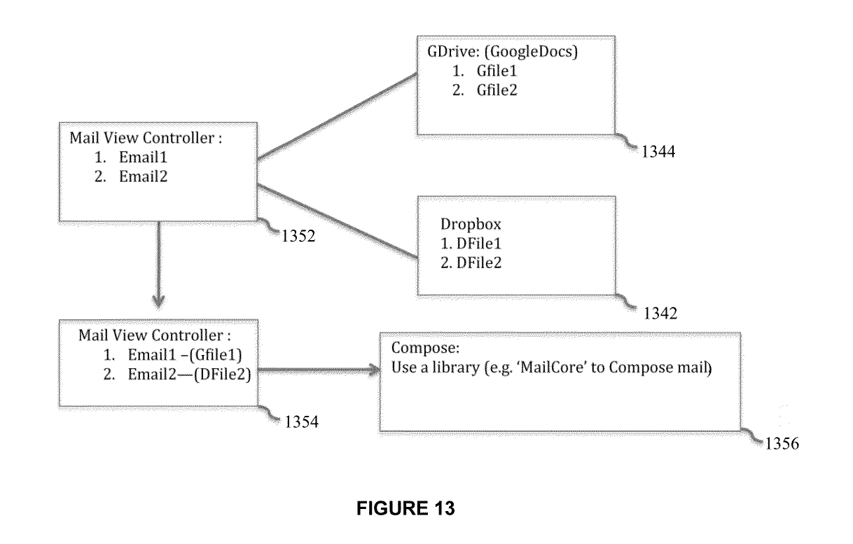

Referring now to the steps 80, 280 and 90, 290 in more detail, reference is made to FIG. 13 along with FIGS. 1-3. Cloud storage devices or remote servers such as GoogleDocs® (Gdrive) or DropBox provide storage for electronic documents to be sent to recipients. In the example shown in FIG. 13, documents are downloaded from the file servers 1342, 1344 to the MailView controller 1352 and subsequently associated with unique email for recipients of Email1 and Email2 (1354) using the MailView controller 1354 and email is composed using MailCore 1356.

The following script provides an additional example of how individual email is generated with recipient specific selected documents.

```
CTCoreMessage *message = [[CTCoreMessage alloc]init];
CTCoreAddress *fromAddr = [CTCoreAddress addressWithName:[loginUserDetails
objectForKey:@“LoginEmail”] email:[loginUserDetails objectForKey:@“LoginEmail”]];
NSMutableArray *toAddsArray = [[NSMutableArray alloc]init];
for(int i=0;i<[self.mailIdData count];i++) {
        NSDictionary *data = [self.mailIdData objectAtIndex:i];
        CTCoreAddress *toAddr = [CTCoreAddress addressWithName:[data
objectForKey:@“fullname”] email:[data objectForKey:@“email”]];
        [toAddsArray addObject:toAddr];
      }
      NSMutableSet *set = [NSMutableSet setWithArray:toAddsArray];//[NSSet set]
initWithArray:toAddsArray];
      [message setTo:set];
      [message setFrom:[NSSet setWithObjectsfromAddr, nil]];
      [message setSubject:subjectFld.text];
      [message setBody:bodyText];
      NSArray *fileArray = [NSArray arrayWithArray:[[self.mailIdData objectAtIndex:0]
objectForKey:@“AllAttachedFiles”]];
      [docArray addObject:fileArray];
      for(int j=1; j< [fileArray count];j++)
      {
        NSString *filename = [[fileArray objectAtIndex:0]
stringByAppendingPathComponent:[fileArray objectAtIndex:j]];
        CTCoreAttachment *attachment1 = [[CTCoreAttachment alloc]
initWithContentsOfFile:filename];
        [message addAttachment:attachment1];
      }
```

### MailView Controller:

Depending on the selected file server or cloud storage service, e.g. Google Docs® or Dropbox the MailView Controller associates the documents with the generated email. The selected files are loaded to the local path and return back to the MailView controller with the file path.

In MailViewController we are Creating a dictionary with Keys and values Like

```
Array {
    Dict1:[
        Email : email1@gmail.com
        AttachFiles: ../Path/File.ext [Local path of the selected file]
        ]
    Dict2:[
        Email : email2@gmail.com
        AttachFiles: ../Path/File.ext
        ]
}
```

### In Compose:

Moving to the compose view with the above data. If we select send, there Composing the mail with to, from, sub, body and attachments.

### For Same Attachment:

From: sender@gmail.com
To: email1@gmail.com, email2@gmail.com
Sub: Test Mail
Body : From Edumail
Attachment: File.ext

### Different Attachment:

Repeating the loop to compose mail for each contacts:

```
From: sender@gmail.com
Sub: Test Mail
Body : From Edumail
For (int i= 0; I <[array count];i++) {
    To: email ’i’ @gmail.com
    Attachment: File ‘i’ .ext
```

It will now be clear that the present method and system have features and advantages not found in prior email systems. The present method and system allows one to send one email to a large group of people and each person in an email list may receive a different document or several different documents from everyone else in the group email.

It will be understood that various details of the presently disclosed subject matter can be changed without departing from the scope of the subject matter disclosed herein. Furthermore, the foregoing description is for the purpose of illustration only, and not for the purpose of limitation.

1. A method for managing a group of recipients to receive one or more recipient selected specific electronic documents to be attached to an electronic message as individually selected document attachments, said method comprising:
(a) identifying recipients to receive a respective email message using a computing device having a computer processor;
(b) selecting one of the recipients using the computing device;
(c) displaying, on a display of the computing device, possible documents to be subsequently attached to a respective email to be sent to the selected one of the recipients in direct response to (b) selecting the one of the recipients to receive one or more documents, prior to attaching documents to an email;
(d) selecting one or more documents using the computing device, to be subsequently attached to an email message after the email message is created;
(e) associating the selected document(s) with the selected recipient;
(f) optionally repeating (b)-(e) for each remaining recipients;
(g) creating a single email message;
(h) generating an email by associating the email message with one of the recipients with respective associated selected document(s) only after completing all iterations of (b)-(e);
(i) sending the email to the one recipient wherein the one recipient receives the email message with the document(s) associated with the one recipient; and
(j) repeating (h) and (i) for the remaining recipients, if the remaining recipients are to receive different document(s) than the one recipient.

2. The method of claim 1, wherein initiating an email message comprises initiating a new email message.

3. The method of claim 1, wherein identifying recipients to receive the email message comprises selecting one or more groups composed of individuals each having an associated respective email address.

4. The method of claim 1, wherein selecting one or more documents to be included with the email comprises selecting documents stored in memory remote from the computing device.

5. The method of claim 4, wherein sending the email message to each of the recipients comprises downloading selected documents to the computing device from a server to which the computing device is operatively associated and sending the email message from the computing device to the recipients with the associated respective documents.

6. The method of claim 1, wherein sending the email message to each of the recipients comprises sending the email message from a remote server, wherein the remote server sends the email message to each of the individuals with the associated respective documents.

7. The method of claim 6, wherein the remote server receives the selected documents from memory remote to the computing device and the remote server sends each email message to respective recipients with the associated respective documents.

8. The method of claim 1, wherein the computing device is a smartphone, tablet computer or personal digital assistant (PDA).

9. The method of claim 1, wherein the computing device is a notebook computer or desktop computer.

10. The method of claim 1, wherein at each iteration of (d) selecting one of the recipients, only a single recipient is selected.

11. The method of claim 1, wherein each (b)-(g) are performed in order.

12. The method of claim 1, wherein (b) selecting one of the recipients associated with the email message using the computing device comprises selecting indicia associated with the recipient.

13. The method of claim 12, wherein the indicia is selected from the group consisting of the name of the recipient, an email address associated with the recipient or icon associated with the recipient.

14. The method of claim 1, wherein (d) selecting one or more documents to be included with the email comprises (i) presenting possible documents to be attached to an email to be sent to the selected one of the recipients after (d) selecting the one of the recipients to receive one or more documents.

15. A system for managing a group of recipients to receive one or more recipient specific electronic documents attached to an electronic message with recipient specific selected document attachments, said system comprising:
a computer processor;
a user interface having an input device and a display;
computer memory;
said computer processor executing computer instruction for:
(a) identifying recipients to receive the email message using the user interface;
(b) selecting one of the recipients using the user interface;
(c) displaying, on a display of the user interface, possible documents to be subsequently attached to a respective email to be sent to the selected one of the recipients in response to (b) selecting the one of the recipients to receive one or more documents, prior to attaching documents to an email;
(d) selecting one or more documents using the user interface, to be subsequently attached to an email message after the email message is created;
(e) associating the selected document(s) with the selected recipient;
(f) optionally repeating (b)-(e) for each remaining recipients;
(g) creating a single email message only after completing all iterations of (b)-(e);
(h) generating an email by associating the email message with one of the recipients with respective associated selected document(s) only after completing all iterations of (b)-(e);
(i) sending the email to the one recipient wherein the one recipient receives the email message with the document(s) associated with the one recipient; and
(j) repeating (h) and (i) for the remaining recipients, if the remaining recipients are to receive different document(s) than the one recipient.

16. The system of claim 15, wherein the processor is associated with a client computing device and (d) selecting one or more documents to be included with the email comprises selecting documents stored on a server remote to the client computing device, the server and the computing device connected via a computer network.

17. The system of claim 16, wherein (h) generating an email by associating the email message with one of the recipients with respective associated selected document(s) comprises downloading the selected documents to the client computing device from the server and (i) sending the email comprises send the email from the client computing device to each of the recipients with the associated respective documents.

18. The system of claim 16, wherein (h) generating an email by associating the email message with one of the recipients with respective associated selected document(s) comprises associating the respective recipient selected one or more documents with the email message on a server and (i) sending the email to the one recipient comprises sending the email from the server.

19. The system of claim 18, wherein the server is the same as the remote server.

20. The system of claim 15, wherein at each iteration of (b) selecting one of the recipients, only a single recipient is selected.

21. The system of claim 15, wherein the client computing device is selected from the group consisting of smartphone, tablet computer and a PDA.
